(19) United States
(12) Patent Application Publication
(10) Pub. No.: US 2008/0278585 A1
(43) Pub. Date: Nov. 13, 2008

(54) Devices, Systems, and Methods Regarding Camera Imaging

(76) Inventor: Michael Philip Greenberg, Goffstown, NH (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/117,021

(22) Filed: May 8, 2008

Related U.S. Application Data
(60) Provisional application No. 60/917,416, filed on May 11, 2007.
(60) Provisional application No. 60/917,420, filed on May 11, 2007.

(51) Int. Cl. H04N 5/225

(52) U.S. Cl. 348/207.1; 348/E05.024

(57) ABSTRACT

Certain exemplary embodiments can provide a system that can comprise a digital camera. The system can comprise an input/output (I/O) circuit adapted to be communicatively coupled to the digital camera. The I/O circuit can be adapted to transmit signals to the digital camera. The I/O circuit can be adapted to transmit signals from the digital camera.

### CROSS-REFERENCE TO RELATED APPLICATIONS

This application claims priority to, and incorporates by reference herein in their entirety: pending U.S. Provisional Patent Application Ser. No. 60/917,416 (Attorney Docket No. 2007P09971US), filed 11 May 2007; and pending U.S. Provisional Patent Application Ser. No. 60/917,420 (Attorney Docket No. 2007P09973US), filed 11 May 2007.

### BACKGROUND

Certain smart cameras can comprise a limited number of input/output connections. In addition to discrete inputs and outputs (e.g. trigger input, strobe and pass/fail outputs), additional assignable connections can be desirable. A circuit that can accept and transmit an input, an output, or a bidirectional data signal with relatively low power consumption might be desired.

### SUMMARY

Certain exemplary embodiments can provide a system that can comprise a digital camera. The system can comprise an input/output (I/O) circuit adapted to be communicatively coupled to the digital camera. The I/O circuit can be adapted to transmit signals to the digital camera. The I/O circuit can be adapted to transmit signals from the digital camera.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a block diagram of an exemplary embodiment of a system 1000;

FIG. 2 is a block diagram of an exemplary embodiment of a system 2000;

FIG. 3 is a block diagram of an exemplary embodiment of a system 3000;

FIG. 4 is a block diagram of an exemplary embodiment of a system 4000;

FIG. 5 is a block diagram of an exemplary embodiment of a system 5000;

FIG. 6 is a block diagram of an exemplary embodiment of a graph regarding signals 6000;

FIG. 7 is a block diagram of an exemplary embodiment of a graph regarding signals 7000; and

FIG. 8 is a flowchart of an exemplary embodiment of a method 8000.

### DETAILED DESCRIPTION

Certain exemplary embodiments can provide a system that can comprise a digital camera. The system can comprise an input/output (I/O) circuit adapted to be communicatively coupled to the digital camera. The I/O circuit can be adapted to transmit signals to the digital camera. The I/O circuit can be adapted to transmit signals from the digital camera.

Certain exemplary embodiments can operate according to a predetermined electrical standard and can be flexible enough to accommodate various interface requirements (e.g. sourcing, sinking, analog, 12 volts, or 24 volts, positive, or negative logical levels, galvanically isolated or non-isolated). Certain exemplary signals can be electrically coupled via external optoisolated modules. Cable pin-outs and optoisolator module sockets can be compatible with an industry-standard of the United States for OPTO-22™ modules which can be adapted to interface with various AC, DC, and/or analog loads and sensors. Module field terminals can be wired in many ways, and thus DC inputs and outputs can be wired either to source or sink current. General purpose input/output circuits (GPIOs) of certain products can be compatible with the industry-standard of the United States for OPTO-22™ modules. Certain circuits can comprise built-in non-isolated outputs having a source current of approximately a positive 24 volts relative to ground, while inputs sink current at ground can be based upon a logic one that is a relatively high voltage near a positive 24 volts relative to ground and/or a logic zero that can be a voltage near zero volts relative to ground. Outputs of the circuits can be capable of driving relatively high currents and inductive loads and can have various forms of built in protection.

Certain circuits can comprise optoisolated inputs or outputs. Relatively high density DC input/output (I/O) modules (or built-in I/Os) can group several input or output points together with a common return connection of approximately a positive 24 volts or approximately a negative 24 volts relative to ground. Outputs can be based upon current sourcing of approximately a positive 24 volts relative to ground. Certain circuits can offer bidirectional inputs. With a purely resistive load, power dissipated by each input circuit can vary as a square of an input voltage.

In certain exemplary embodiments input signals to the I/O circuit, can comply with current and voltage ranges representing binary one or zero states. Current ranges can be set based upon leakage or bias currents of a connected signal source device. Voltage ranges can be established based upon a noise margin in order to attempt to avoid spurious operation. Voltage and current ranges for certain exemplary embodiments can be in accordance with high and low signal criteria as indicated in TABLE I.

TABLE I

| | H Signal Rated Voltage | | | | |
|---|---|---|---|---|---|
| | +24 V | +24 V¹⁾ | +48 V | +48 V¹⁾ | Unit |
| Voltage Range³⁾ | +15-+30 | +11-+30 | +33-+60 | +30-+60 | V |
| Current Range | +2-+15 | +6-+30 | +2-+15 | +6-+30 | mA |
| | L Signal Rated Voltage | | | | |
| | 0 V | 0 V | 0 V | 0 V | Unit |
| Voltage Range²⁾ | −3-+5 | −3-+5 | −6-+10 | −6-+10 | V |
| Current Range⁴⁾ | ND-+15 | ND-+30 | ND-+15 | ND-+30 | mA |

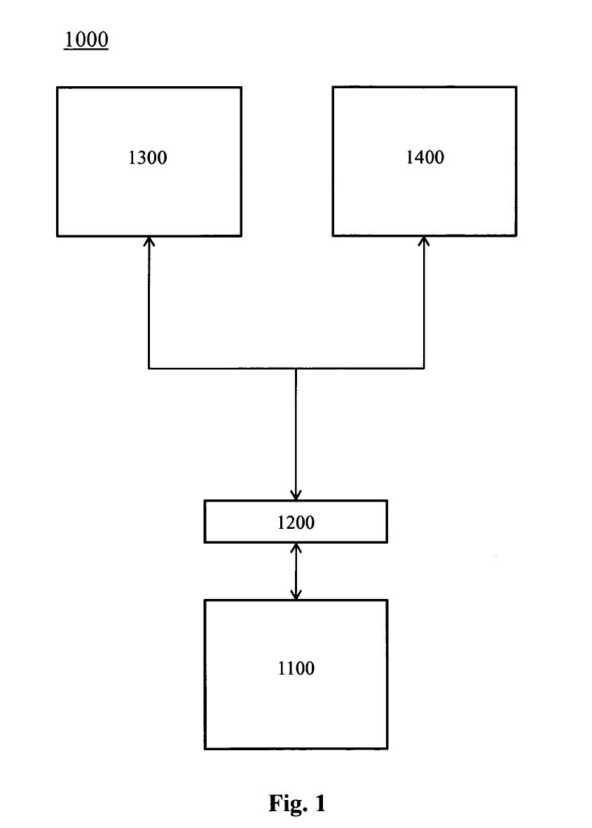

FIG. 1 is a block diagram of an exemplary embodiment of a system 1000, which can comprise an imaging device 1100, an I/O circuit 1200, a first I/O device 1300, and a second I/O device 1400. In certain exemplary embodiments, imaging device 1100 can be a digital camera and/or a machine vision device.

I/O circuit 1200 can be adapted to receive and transmit signals to and/or from imaging device 1100. In certain exemplary embodiments I/O circuit 1200 can comprise one or more optoisolators, which can be adapted to resist a propagation of stray electrical signals between imaging device 1100 and first I/O device 1300 or second I/O device 1400. I/O circuit 1200 can be adapted to receive and/or transmit direct current signals of each of a positive polarity and a negative polarity. I/O circuit 1200 can be adapted transmit bidirectional signals between imaging device 1100 and first I/O device 1300 or second I/O device 1400. First I/O device 1300 and/or second I/O device 1400 can be a device such as an illumination sensor, image sensor, a status sensor, illumination controller, focus controller, zoom lens controller, camera positioned, exposure controller, and/or image resolution controller, etc.

I/O circuit 1200 can be adapted to be communicatively coupled to imaging device 1100. I/O circuit 1200 can be adapted to transmit direct current signals of a positive polarity relative to ground between imaging device 1100 and first I/O device 1300 and/or second I/O device 1400. I/O circuit 1200 can be adapted to transmit direct current signals of a negative polarity relative to ground between imaging device 1100 and first I/O device 1300 and/or second I/O device 1400. I/O circuit 1200 can comprise a bidirectional zener diode adapted to establish a voltage threshold of an input to I/O circuit 1200. In certain exemplary embodiments, the bidirectional zener diode can be electrically coupled a pair of back-to-back current limiting diodes. The pair of back-to-back current limiting diodes can be adapted to determine a power dissipation of I/O circuit 1200.

In certain exemplary embodiments, the bidirectional zener diode can be electrically coupled with a threshold resistor. The threshold voltage can be established by the bidirectional zener diode and the threshold resistor. In certain exemplary embodiments, the threshold voltage can be approximately half of a reference voltage applied to I/O circuit 1200. In certain exemplary embodiments, I/O circuit 1200 can comprises a thermistor, which can be adapted to limit a maximum power dissipation of I/O circuit 1200. In certain exemplary embodiments, I/O circuit 1200 can comprises a constant current diode, which can be adapted to limit a maximum power dissipation of I/O circuit 1200.

In certain exemplary embodiments, I/O circuit 1200 can be adapted to receive and/or transmit a signal of approximately 12 volts, a signal of approximately 24 volts, and/or a bidirectional signal. In certain exemplary embodiments, power dissipated by I/O circuit 1200 can be proportional to a voltage input to I/O circuit 1200.

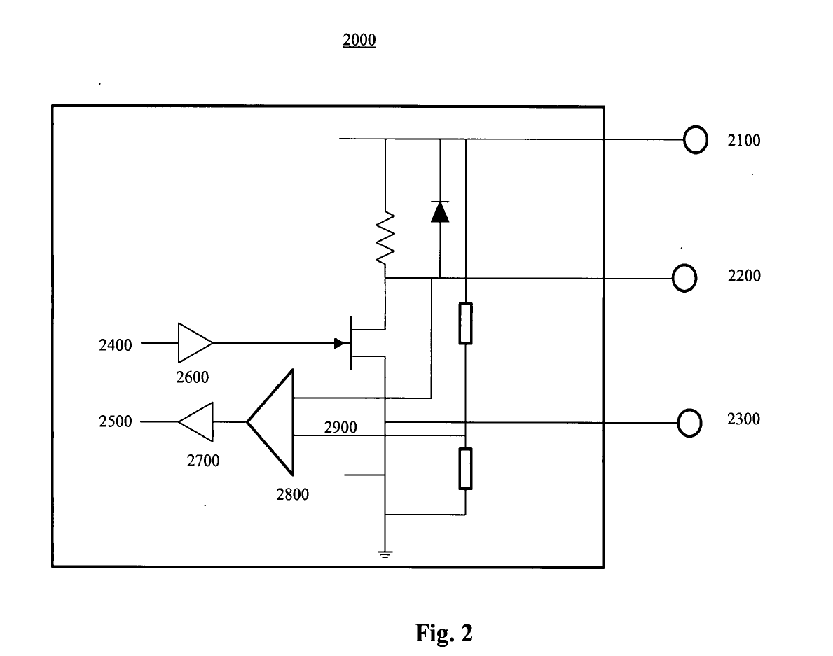

FIG. 2 is a block diagram of an exemplary embodiment of a system 2000, which can be an I/O circuit such as I/O circuit 1200 of FIG. 1. In certain exemplary embodiments, system 2000 can be adapted to drive relatively high current and/or inductive loads. System 2000 can comprise a first I/O terminal 2100, a second I/O terminal 2200, a third I/O terminal 2300, an output from imaging device 2400, an input to imaging device 2500, a first buffer 2600, a second buffer 2700, a comparator 2800, and a comparator reference input 2900. First I/O terminal 2100 can be electrically coupled to a reference voltage signal, which can vary from between approximately 5 direct current volts to approximately 32 direct current volts. Second I/O terminal 2200 can be electrically coupled to an external device and/or system that can be adapted to communicate with an imaging device. Third I/O terminal 2300 can be electrically coupled to a ground. In certain exemplary embodiments, the reference voltage signal and the ground can be electrically coupled to a plurality of I/O circuits, such as I/O circuit 2000. Comparator 2800 can be adapted to compare an input signal received by system 2000 to a threshold value and thereby determine whether the input signal is indicative of a binary value of 0 or a binary value of 1.

If the reference voltage is not electrically coupled to system 2000, operation of system 2000 can default to Transistor-Transistor Logic (TTL). In certain exemplary embodiments, the reference voltage can be electrically coupled to system 2000 subsequent to and/or concurrently with a connection of electrical loads to system 2000. When used as an input, the external device and/or system can sink an electrical current to ground. In certain exemplary embodiments, an input logic threshold of system 2000 can be approximately half of the reference voltage.

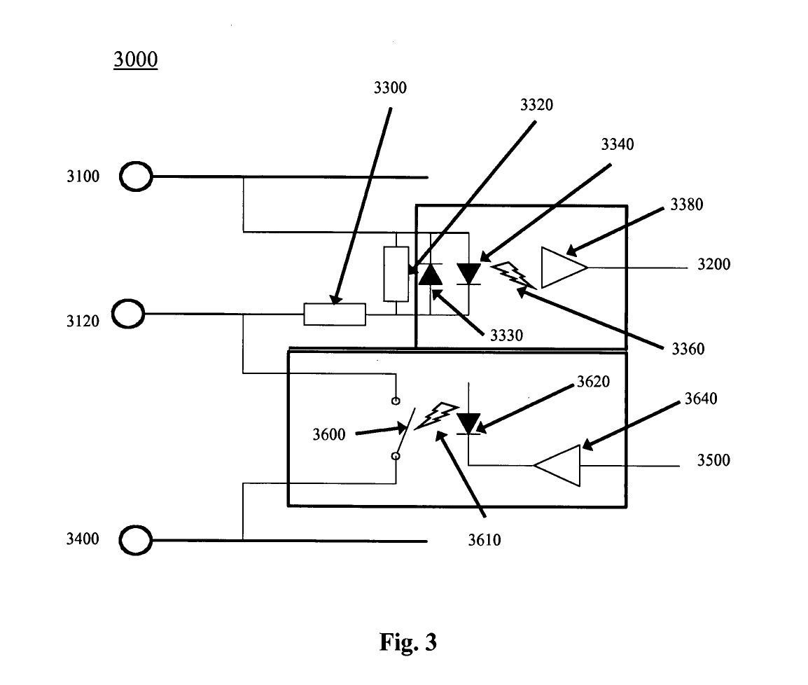

FIG. 3 is a block diagram of an exemplary embodiment of a system 3000, which can be an I/O circuit such as I/O circuit 1200 of FIG. 1. In certain exemplary embodiments, system 2000 can comprise a first I/O terminal 3100, a second I/O terminal 3120, a third I/O terminal 3400, a series device 3300, a threshold resistor 3320, a first diode 3330, a second diode 3340, an first optoisolator 3360, a first buffer 3380, an input to imaging device 2500, a bidirectional field effect transistor switch 3600, a second optoisolator 3610, a third diode 3620, a second buffer 3640, and an output from imaging device 3500. In certain exemplary embodiments, input and/or output signals associated with system 3000 can be optoisolated via first optoisolator 3360 or second optoisolator 3610. System 3000 can be adapted to function in either of a sourcing or sinking configuration. Each solid state relay output can be internally protected. Certain exemplary embodiments can use a shield for a serial return signal. In certain exemplary embodiments, threshold resistor 3320 can be used to establish a voltage threshold for system 3000. In certain exemplary embodiments, series device 3300 can establish a power dissipation of system 3000. Series device 3300 can be a resistor, a thermistor, and/or a constant current diode.

First I/O terminal 3100 can be electrically coupled to a reference voltage signal, which can vary from between approximately 5 direct current volts to approximately 32 direct current volts. Second I/O terminal 3120 can be electrically coupled to an external device and/or system that can be adapted to communicate with an imaging device. Third I/O terminal 3400 can be electrically coupled to a ground. In certain exemplary embodiments, the reference voltage signal and the ground can be electrically coupled to a plurality of I/O circuits, such as I/O circuit 3000. A signal provided to second I/O terminal 3120 can have a positive direct current polarity relative to ground. The signal provided to second I/O terminal 3120 can have a negative direct current polarity relative to ground. Each of first diode 3330 and second diode 3340 can be light emitting diodes (LEDs) associated with first optoisolator 3360. An illumination of first diode 3330 or second diode 3340 can cause a signal to be transmitted to first buffer 3380. In certain exemplary embodiments, the illustrated anti-parallel arrangement of first diode 3330 and second diode 3340 in system 3000 can result in a signal transmission to first buffer 3380 responsive to an input signal, obtained via second I/O terminal 3120, having a positive polarity relative to ground and/or a signal having a negative polarity to ground. Third diode 3630 can be an LED associated with second optoisolator 3610. An illumination of third diode 3630 can cause switch 3600 to conduct current and a signal to be transmitted to second I/O terminal 3120.

In certain exemplary embodiments, depending on specific values of threshold and series resistors receiving input signals, the operating voltage and current can be set for operation over a wide range of voltages and currents, including TTL to a positive direct current voltage of approximately 48 and/or a negative direct current voltage of approximately 48. Such values can be set based upon a maximum input device operating current and/or an amount of power dissipation that can be tolerated inside a housing of the imaging device (e.g., a smart camera).

First buffer 3380 can be adapted to temporarily store a binary value of a signal obtained via second I/O terminal 3120. The binary value can be read and/or transferred to an imaging device responsive to a signal from the imaging device. Second buffer 3500 can be adapted to temporarily store a binary signal received from the imaging device. The binary signal can be transmitted to second I/O terminal 3120 via third diode 3620, second optoisolator 3610, and bidirectional field effect transistor switch 3600.

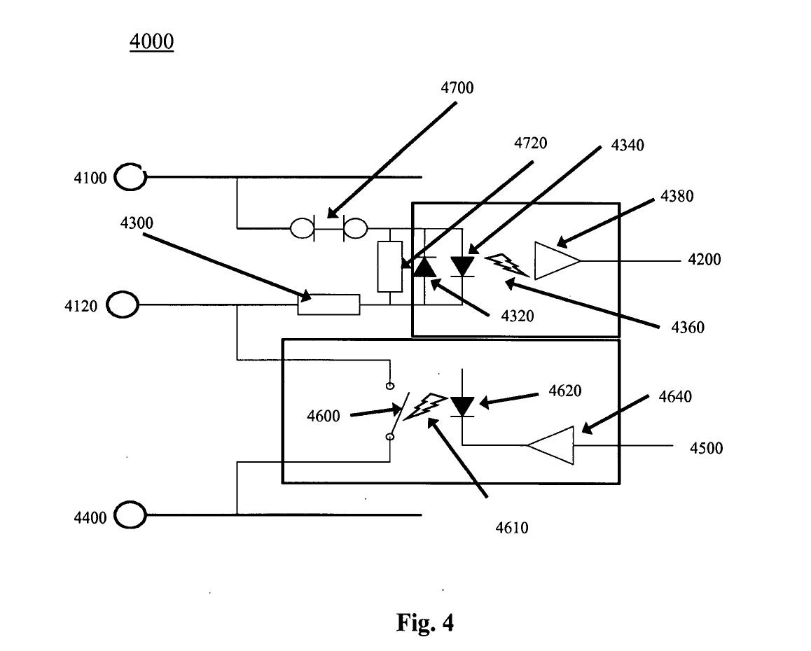

FIG. 4 is a block diagram of an exemplary embodiment of a system 4000, which can be an I/O circuit such as I/O circuit 1200 of FIG. 1. In certain exemplary embodiments, system 4000 can comprise a first I/O terminal 4100, a second I/O terminal 4120, a third I/O terminal 4400, a first resistor 4300, a pair of back-to-back current limiting diodes 4700, a second resistor 4720, a first diode 4320, a second diode 4340, an first optoisolator 4360, a first buffer 4380, an input to imaging device 4200, a bidirectional field effect transistor switch 4600, a second optoisolator 4610, a third diode 4620, a second buffer 4640, and an output from imaging device 4500. In certain exemplary embodiments, input and/or output signals associated with system 4000 can be optoisolated via first optoisolator 4360 or second optoisolator 4610.

First I/O terminal 4100 can be electrically coupled to a reference voltage signal, which can vary from between approximately 5 direct current volts to approximately 32 direct current volts. Second I/O terminal 4120 can be electrically coupled to an external device and/or system that can be adapted to communicate with an imaging device. Third I/O terminal 4400 can be electrically coupled to a ground. In certain exemplary embodiments, the reference voltage signal and the ground can be electrically coupled to a plurality of I/O circuits, such as I/O circuit 4000. A signal provided to second I/O terminal 4120 can have a positive direct current polarity relative to ground. The signal provided to second I/O terminal 4120 can have a negative direct current polarity relative to ground.

Pair of back-to-back current limiting diodes 4700 can be electrically coupled in series with a circuit transmitting the reference voltage signal. Once in a binary one current/voltage region, an input current can be constant, which can result in power dissipation being proportional to voltage change rather than the square of the voltage change.

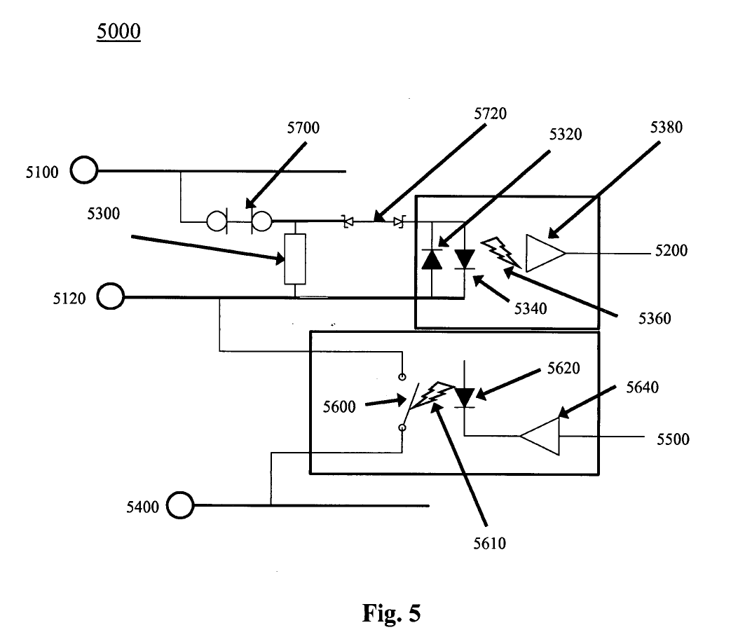

FIG. 5 is a block diagram of an exemplary embodiment of a system 5000, which can be an I/O circuit such as I/O circuit 1200 of FIG. 1. In certain exemplary embodiments, system 5000 can comprise a first I/O terminal 5100, a second I/O terminal 5120, a third I/O terminal 5400, a threshold resistor 5300, a pair of back-to-back current limiting diodes 5700, a bidirectional zener diode 5720, a first diode 5320, a second diode 5340, an first optoisolator 5360, a first buffer 5380, an input to imaging device 5200, a bidirectional field effect transistor switch 5600, a second optoisolator 5610, a third diode 5620, a second buffer 5640, and an output from imaging device 5500. In certain exemplary embodiments, input and/or output signals associated with system 5000 can be optoisolated via first optoisolator 5360 or second optoisolator 5610.

System 5000 can be multiply assignable in that system 5000 can be communicatively coupled to a plurality of different devices and/or systems including systems that provide and/or receive positive direct current voltages relative to ground and systems that provide and/or receive negative direct current voltages relative to ground. In certain exemplary embodiments, system 5000 can receive and/or transmit input, output, and/or bidirectional data signals. In certain exemplary embodiments, an electrical standard to which each signal conforms can accommodate various interface requirements (e.g. sourcing, sinking, analog, approximately 12 volts, approximately 24 volts, positive logic levels, negative logical levels, galvanically isolated, and/or galvanically non-isolated, etc.).

An input operating range can also be enhanced by using nonlinear devices to control power, a voltage threshold, and/or a current threshold. For example, placing bidirectional zener diode 5720 in series with first optoisolator 5360, and the combination of bidirectional zener diode 5720 and first optoisolator 5360 in parallel with threshold resistor 5300 can be used to establish a relatively accurate voltage threshold. In certain exemplary embodiments, a thermistor or constant current diode can be used in system 5000 to limit a maximum power dissipated.

In certain exemplary embodiments, pair of series current limiting diodes 5700 can electrically coupled in series with bidirectional zener diode 5720. Once in a binary one current/voltage region, an input current can be constant, which can result in power dissipation of system 5000 being proportional to voltage change rather than the square of the voltage change.

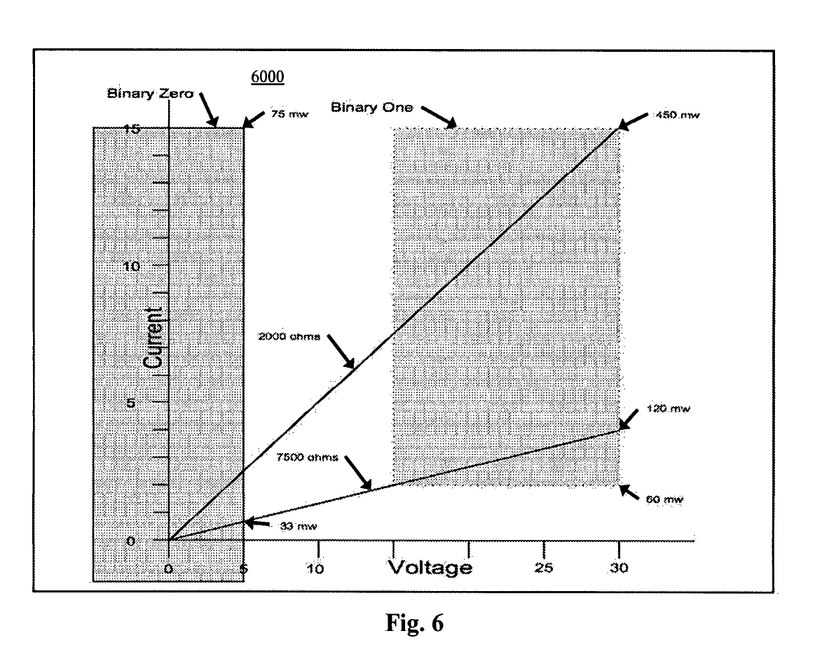

FIG. 6 is a block diagram of an exemplary embodiment of a graph regarding signals 6000, which plots specification limits for signaling of approximately a positive 24 volts relative to ground as indicated in the first column of TABLE I. Graph regarding signals 6000 illustrates curves of current as a function of voltage for exemplary I/O circuits. Curve resistance values can be primarily based upon resistors in series with inputs (e.g., series device 3300 in FIG. 3 assuming a resistance of a threshold resistor 3320 is relatively small). The curve labeled “2000 ohms” is indicative of a curve based upon an exemplary system having a resistance of approximately 2000 ohms. The callout labeled “450 mw” is the power (V×I) for the single point where the “2000 ohms” curve intersects the right edge of the shaded area labeled “Binary One” (maximum voltage and current). The curve labeled “7500 ohms” is indicative of a curve based upon an exemplary system having a resistance of approximately 7500 ohms. The callout labeled “33 mw” is the power (V×I) for the single point where the “7500 ohms” curve intersects the right edge of the shaded area labeled “Binary Zero” (the maximum voltage and current for which a signal can represent a binary value of zero in an exemplary system). The callout labeled “120 mw” is the power for the single point where the “7500 ohms” curve intersects the right edge of the shaded area labeled “Binary One”. The “60 mw” callout” represents the power calculation for the lower right corner of the “Binary One” area (maximum specified voltage, minimum specified current).

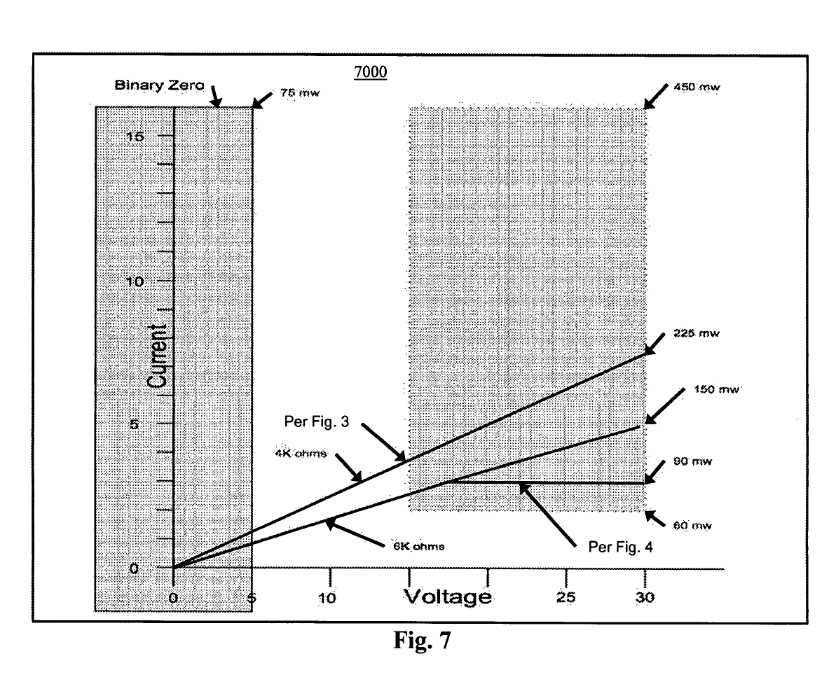

FIG. 7 is a block diagram of an exemplary embodiment of a graph regarding signals 7000, which can illustrate non-linear input curves regarding certain exemplary I/O circuit. The bottom curve (90 mw) indicates an input impedance and power consumption of system 4000 of FIG. 4. A 3 milliamp (“ma”) current limiting curve is assumed to allow for tolerance buildup. Certain exemplary I/O circuits can provide relatively low power consumption. The curve labeled “4K ohms” is indicative of a curve based upon an exemplary system having a resistance of approximately 4000 ohms. The callout labeled “225 mw” is the power for the single point where the “4K ohms” curve intersects the right edge of the shaded area labeled “Binary One”. The curve labeled “6K ohms” is indicative of a curve based upon an exemplary system having a resistance of approximately 6000 ohms. The callout labeled “150 mw” is the power (V×I) for the single point where the “6K ohms” curve intersects the right edge of the shaded area labeled “Binary One”. The callout labeled “90 mw” is the power calculated at a location on graph regarding signals 7000 where a 3 milliamp constant current curve intersects the right edge of the Binary One area (maximum voltage). The “60 mw” callout” represents the power calculation for the lower right corner of the “Binary One” area (maximum specified voltage, minimum specified current).

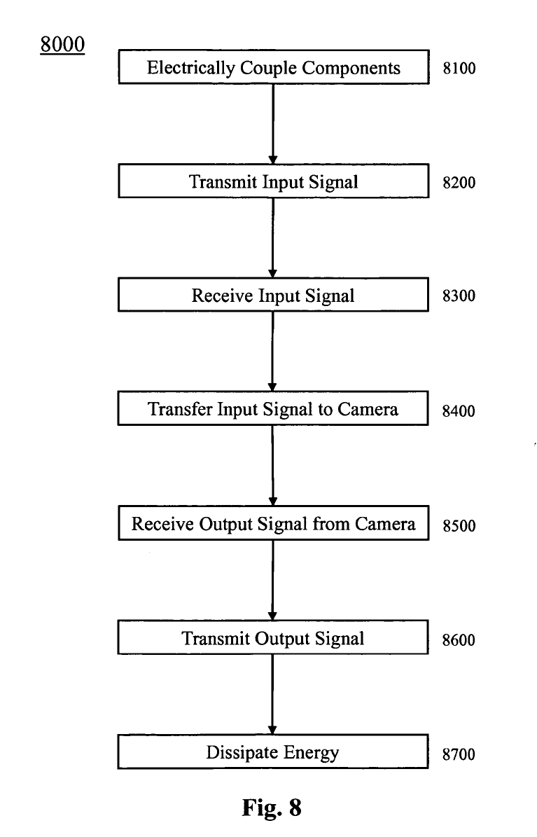

FIG. 8 is a flowchart of an exemplary embodiment of a method 8000. Activities of method 8000 can be performed automatically. At activity 8100, components of an I/O circuit can be electrically coupled and/or caused to be electrically coupled to a set of devices and/or systems. For example, an I/O circuit can be electrically and/or communicatively coupled to an imaging device, such as a digital camera. The I/O circuit can be electrically and/or communicatively coupled to an external device and/or system. The I/O circuit can be adapted to transmit direct current signals of a positive polarity relative to ground. The I/O circuit can be adapted to transmit direct current signals of a negative polarity relative to ground.

The I/O circuit can comprise a bidirectional zener diode adapted to establish a voltage threshold of an input to the I/O circuit. The bidirectional zener diode can be electrically coupled to a pair of back-to-back current limiting diodes. The pair of back-to-back current limiting diodes can be adapted to determine a power dissipation of the I/O circuit. In certain exemplary embodiments, the bidirectional zener diode can be electrically coupled to a threshold resistor. The threshold resistor and the bidirectional zener diode can be adapted to establish a threshold voltage of the I/O circuit. In certain exemplary embodiments, the threshold voltage can be approximately half of a reference voltage applied to the I/O circuit.

In certain exemplary embodiments, a thermistor can be electrically coupled to the I/O circuit. The thermistor can be adapted to limit a maximum power dissipation of the I/O circuit. In certain exemplary embodiments, a constant current diode can be electrically coupled to the I/O circuit. The constant current diode can be adapted to limit a maximum power dissipation of the I/O circuit. The I/O circuit can be adapted to transmit a signal of approximately 12 volts, approximately 24 volts, and/or a bidirectional signal, etc.

At activity 8200, an input signal can be provided to the I/O circuit by an external device and/or system. For example, the input signal can be a signal regarding a sensed illumination, location of an object for which an image is desired, and/or status of a device and/or system, etc. The input signal can be a signal regarding a controlled illumination, camera focus, zoom lens position, camera position, image exposure, and/or image resolution, etc.

At activity 8300, the input signal can be received by the I/O circuit from the external device and/or system. The input signal can have a positive polarity relative to ground or a negative polarity relative to ground.

At activity 8400, the input signal can be provided to an imaging device via the I/O circuit. In certain exemplary embodiments, the imaging device can be a digital camera. The I/O circuit can be adapted to optoisolate the external device and/or system from the imaging device. The imaging device can receive the input signal via an optoisolator.

At activity 8500, an output signal can be received from the imaging device. Certain exemplary embodiments can be adapted to cause a signal to be transmitted from the imaging device via the I/O circuit. The signal can be associated with an image obtained via the digital camera. For example, the signal can be a status signal regarding the digital camera, an acknowledgement of a setting to an illumination device, an instruction for a setting to an illumination device, an instruction for positioning to a positioning controller, and/or a signal adapted to request information from a sensor (e.g., an illumination sensor).

At activity 8600, the output signal can be transmitted via the I/O circuit to the external device and/or system. The output signal can be adapted request information from and/or to control the external device and/or system.

At activity 8700, power and/or energy can be dissipated from the I/O circuit. Certain exemplary embodiments can be adapted to cause a dissipation of power at the I/O circuit. The dissipation of power can be proportional to a voltage input to the I/O circuit.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
access—(n) a permission, liberty, right, mechanism, or ability to enter, approach, communicate with and/or through, make use of, and/or pass to and/or from a place, thing, and/or person; (v) to enter, approach, communicate with and/or through, make use of, and/or pass to and/or from.
activity—an action, act, deed, function, step, and/or process and/or a portion thereof.
adapted to—suitable, fit, and/or capable of performing a specified function.
also—in addition to.
analog signal—a signal formed from continuous measurement and/or input.
and/or—either in conjunction with or in alternative to.
apparatus—an appliance and/or device for a particular purpose.
applied—incident directly and/or indirectly upon.
approximately—about and/or nearly the same as.
back-to-back current limiting diodes—two electronic devices, each of which is adapted to partially restrain current flow in one direction, that are electrically coupled in series such that, for a given input polarity, one device is forward biased and the other device is reversed biased.
bidirectional—adapted to transmit a first electrical signal from a first location to a second location in a direct current circuit and adapted to transmit a second electrical signal from the second location to the first location in the direct current circuit.
can—is capable of, in at least some embodiments.
cause—to bring about, provoke, precipitate, produce, elicit, be the reason for, result in, and/or effect.
circuit—an electrically conductive pathway and/or a communications connection established across two or more switching devices comprised by a network and between corresponding end systems connected to, but not comprised by the network.
combination—two or more values.
communicatively—linking in a manner that facilitates communications.
comprise—to include, but not be limited to, what follows.
configure to design, arrange, set up, shape, and/or make suitable and/or fit for a specific purpose.
constant—continually occurring; persistent; and/or unchanging.
control—(n) a mechanical or electronic device used to operate a machine within predetermined limits; (v) to exercise authoritative and/or dominating influence over, cause to act in a predetermined manner, direct, adjust to a requirement, and/or regulate.
controller—a device and/or set of machine-readable instructions for performing one or more predetermined and/or user-defined tasks. A controller can comprise any one or a combination of hardware, firmware, and/or software. A controller can utilize mechanical, pneumatic, hydraulic, electrical, magnetic, optical, informational, chemical, and/or biological principles, signals, and/or inputs to perform the task(s). In certain embodiments, a controller can act upon information by manipulating, analyzing, modifying, converting, transmitting the information for use by an executable procedure and/or an information device, and/or routing the information to an output device. A controller can be a central processing unit, a local controller, a remote controller, parallel controllers, and/or distributed controllers, etc. The controller can be a general-purpose microcontroller, such the Pentium IV series of microprocessor manufactured by the Intel Corporation of Santa Clara, Calif., and/or the HCO8 series from Motorola of Schaumburg, Ill. In another embodiment, the controller can be an Application Specific Integrated Circuit (ASIC) or a Field Programmable Gate Array (FPGA) that has been designed to implement in its hardware and/or firmware at least a part of an embodiment disclosed herein.
corresponding—related, associated, accompanying, similar in purpose and/or position, conforming in every respect, and/or equivalent and/or agreeing in amount, quantity, magnitude, quality, and/or degree.
couple—to join, connect, and/or link two things together.
create—to make, form, produce, generate, bring into being, and/or cause to exist.
data—information represented in a form suitable for processing by an information device.
define—to establish the meaning, relationship, outline, form, and/or structure of; and/or to precisely and/or distinctly describe and/or specify.
determine—to obtain, calculate, decide, deduce, establish, and/or ascertain.
device—a machine, manufacture, and/or collection thereof.
digital—non-analog; discrete.
digital camera—a camera that captures an image not on film, but in an electronic imaging sensor that takes the place of film.
direct current—a non-alternating electric current.
dissipate—to cause to lose irreversibly. For example, transferring energy to a surrounding environment dissipates that energy.
electrically couple—to connect in a manner adapted to allow a flow of electricity therebetween.
establish—to create, form, and/or set-up.
exceeds—to be greater than.
field effect transistor (FET)—a device that regulates current and/or voltage and acts as a switch and/or gate for electronic signals; the device comprising a semiconductor channel that is adapted to control an electrical signal flowing through the device via an electric field that, when applied, controls conductivity of the channel.
from—used to indicate a source.
generate—to create, produce, render, give rise to, and/or bring into existence.
ground—an electrical potential that is approximately equal to that of the earth.
half—a value obtained by dividing a quantity by two.
haptic—involving the human sense of kinesthetic movement and/or the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.
image—an at least two-dimensional representation of an entity and/or phenomenon.
information—facts, terms, concepts, phrases, expressions, commands, numbers, characters, and/or symbols, etc., that are related to a subject. Sometimes used synonymously with data, and sometimes used to describe organized, transformed, and/or processed data. It is generally possible to automate certain activities involving the management, organization, storage, transformation, communication, and/or presentation of information.
information device—any device on which resides a finite state machine capable of implementing at least a portion of a method, structure, and/or or graphical user interface described herein. An information device can comprise well-known communicatively coupled components, such as one or more network interfaces, one or more processors, one or more memories containing instructions, one or more input/output (I/O) devices, and/or one or more user interfaces (e.g., coupled to an I/O device) via which information can be rendered to implement one or more functions described herein. For example, an information device can be any general purpose and/or special purpose computer, such as a personal computer, video game system (e.g., PlayStation, Nintendo Gameboy, X-Box, etc.), workstation, server, minicomputer, mainframe, supercomputer, computer terminal, laptop, wearable computer, and/or Personal Digital Assistant (PDA), iPod, mobile terminal, Bluetooth device, communicator, “smart” phone (such as a Treo-like device), messaging service (e.g., Blackberry) receiver, pager, facsimile, cellular telephone, a traditional telephone, telephonic device, a programmed microprocessor or microcontroller and/or peripheral integrated circuit elements, a digital signal processor, an ASIC or other integrated circuit, a hardware electronic logic circuit such as a discrete element circuit, and/or a programmable logic device such as a PLD, PLA, FPGA, or PAL, or the like, etc.
input—a signal, data, and/or information provided to a processor, device, and/or system.
input/output circuit—an electrical circuit adapted to transmit a first signal to a first electrically coupled device and/or system and adapted to receive a second signal from a second electrically coupled device and/or system that is potentially distinct from the first electrically coupled device and/or system.
limit—a point beyond which something cannot or may not proceed.
machine instructions—directions adapted to cause a machine, such as an information device, to perform one or more particular activities, operations, and/or functions. The directions, which can sometimes form an entity called a “processor”, “kernel”, “operating system”, “program”, “application”, “utility”, “subroutine”, “script”, “macro”, “file”, “project”, “module”, “library”, “class”, and/or “object”, etc., can be embodied as machine code, source code, object code, compiled code, assembled code, interpretable code, and/or executable code, etc., in hardware, firmware, and/or software.
machine readable medium—a physical structure from which a machine, such as an information device, computer, microprocessor, and/or controller, etc., can obtain and/or store data, information, and/or instructions. Examples include memories, punch cards, and/or optically-readable forms, etc.
maximum—a greatest extent.
may—is allowed and/or permitted to, in at least some embodiments.
memory device—an apparatus capable of storing analog or digital information, such as instructions and/or data. Examples include a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory device can be coupled to a processor and/or can store instructions adapted to be executed by processor, such as according to an embodiment disclosed herein.
method—a process, procedure, and/or collection of related activities for accomplishing something.
modify—to change, cause to change, edit, alter, replace, delete, and/or correct.
negative—less than approximately zero
network—a communicatively coupled plurality of nodes, communication devices, and/or information devices. Via a network, such devices can be linked, such as via various wireline and/or wireless media, such as cables, telephone lines, power lines, optical fibers, radio waves, and/or light beams, etc., to share resources (such as printers and/or memory devices), exchange files, and/or allow electronic communications therebetween. A network can be and/or can utilize any of a wide variety of sub-networks and/or protocols, such as a circuit switched, public-switched, packet switched, connection-less, wireless, virtual, radio, data, telephone, twisted pair, POTS, non-POTS, DSL, cellular, telecommunications, video distribution, cable, terrestrial, microwave, broadcast, satellite, broadband, corporate, global, national, regional, wide area, backbone, packet-switched TCP/IP, IEEE 802.03, Ethernet, Fast Ethernet, Token Ring, local area, wide area, IP, public Internet, intranet, private, ATM, Ultra Wide Band (UWB), Wi-Fi, BlueTooth, Airport, IEEE 802.11, IEEE 802.11a, IEEE 802.11b, IEEE 802.11g, X-10, electrical power, multi-domain, and/or multi-zone sub-network and/or protocol, one or more Internet service providers, and/or one or more information devices, such as a switch, router, and/or gateway not directly connected to a local area network, etc., and/or any equivalents thereof
network interface—any physical and/or logical device, system, and/or process capable of coupling an information device to a network. Exemplary network interfaces comprise a telephone, cellular phone, cellular modem, telephone data modem, fax modem, wireless transceiver, Ethernet card, cable modem, digital subscriber line interface, bridge, hub, router, or other similar device, software to manage such a device, and/or software to provide a function of such a device.
obtain—to receive, get, take possession of, procure, acquire, calculate, determine, and/or compute.
optically isolate—to transfer a signal between elements of a first electrical circuit and a second electrical circuit via an optical transmission path, which causes the first electrical circuit to be electrically isolated from the second electrical circuit.
output—(n) something produced and/or generated; data produced by an information device executing machine-readable instructions; and/or the energy, power, work, signal, and/or information produced by a system. (v) to provide, produce, manufacture, and/or generate.
packet—a generic term for a bundle of data organized in a specific way for transmission, such as within and/or across a network, such as a digital packet-switching network, and comprising the data to be transmitted and certain control information, such as a destination address.
pair—a set of two items.
parallel—an arrangement of components in an electrical circuit that splits an electrical current into two or more paths.
perform—to begin, take action, do, fulfill, accomplish, carry out, and/or complete, such as in accordance with one or more criterion.
perform—to begin, take action, do, fulfill, accomplish, carry out, and/or complete, such as in accordance with one or more criterion.
plurality—the state of being plural and/or more than one.
polarity—an electrical potential relative to a reference electrical potential that determines a direction of electron flow, from negative to positive, in a direct current circuit.
positive—greater than approximately zero.
power—energy, a measure of energy and/or work, and/or a rate at which work is done, expressed as the amount of work per unit time and commonly measured in units such as watt and horsepower.
predetermine—to determine, decide, or establish in advance.
predetermined threshold—a limit established in advance.
process—(n.) an organized series of actions, changes, and/or functions adapted to bring about a result. (v.) to perform mathematical and/or logical operations according to programmed instructions in order to obtain desired information and/or to perform actions, changes, and/or functions adapted to bring about a result.
processor—a hardware, firmware, and/or software machine and/or virtual machine comprising a set of machine-readable instructions adaptable to perform a specific task. A processor can utilize mechanical, pneumatic, hydraulic, electrical, magnetic, optical, informational, chemical, and/or biological principles, mechanisms, signals, and/or inputs to perform the task(s). In certain embodiments, a processor can act upon information by manipulating, analyzing, modifying, and/or converting it, transmitting the information for use by an executable procedure and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium IV series of microprocessor manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein. A processor can reside on and use the capabilities of a controller.
proportional—having a ratio that is approximately constant.
provide—to furnish, supply, give, convey, send, and/or make available.
read—to obtain from a memory device.
receive—to gather, take, acquire, obtain, accept, get, and/or have bestowed upon.
reference—an indicator that provides a value and/or orientation relative to something else.
relative—considered with reference to and/or in comparison to something else.
render—to display, annunciate, speak, print, and/or otherwise make perceptible to a human, for example as data, commands, text, graphics, audio, video, animation, and/or hyperlinks, etc., such as via any visual, audio, and/or haptic mechanism, such as via a display, monitor, printer, electric paper, ocular implant, cochlear implant, speaker, etc.
repeatedly—again and again; repetitively.
request—(v.) to express a need and/or desire for; to inquire and/or ask for. (n.) that which communicates an expression of desire and/or that which is asked for.
resistor—a two-terminal electronic component that opposes an electric current by producing a voltage drop between the two terminals in accordance with Ohm's law.
result—an outcome and/or consequence of a particular action, operation, and/or course.
said—when used in a system or device claim, an article indicating a subsequent claim term that has been previously introduced.
select—to make and/or indicate a choice and/or selection from among alternatives.
series—an arrangement of components in an electrical circuit one after the other so that the electrical current is not split therebetween.
set—a related plurality of predetermined elements; and/or one or more distinct items and/or entities having a specific common property or properties.
signal—information, such as machine instructions for activities and/or one or more letters, words, characters, symbols, signal flags, visual displays, and/or special sounds, etc. having prearranged meaning, encoded as automatically detectable variations in a physical variable, such as a pneumatic, hydraulic, acoustic, fluidic, mechanical, electrical, magnetic, optical, chemical, and/or biological variable, such as power, energy, pressure, flowrate, viscosity, density, torque, impact, force, frequency, phase, voltage, current, resistance, magnetomotive force, magnetic field intensity, magnetic field flux, magnetic flux density, reluctance, permeability, index of refraction, optical wavelength, polarization, reflectance, transmittance, phase shift, concentration, and/or temperature, etc. Depending on the context, a signal and/or the information encoded therein can be synchronous, asynchronous, hard real-time, soft real-time, non-real time, continuously generated, continuously varying, analog, discretely generated, discretely varying, quantized, digital, broadcast, multicast, unicast, transmitted, conveyed, received, continuously measured, discretely measured, processed, encoded, encrypted, multiplexed, modulated, spread, de-spread, demodulated, detected, de-multiplexed, decrypted, and/or decoded, etc.
specify—to describe, characterize, indicate, and/or state explicitly and/or in detail.
store—to place, hold, retain, enter, and/or copy into and/or onto a machine-readable medium.
substantially—to a considerable, large, and/or great, but not necessarily whole and/or entire, extent and/or degree.
switch—(n) a mechanical, electrical, and/or electronic device that opens and/or closes circuits, completes and/or breaks an electrical path, and/or selects paths and/or circuits and/or a device that establishes a connection between disparate transmission path segments in a network (or between networks). (v) to electrically energize or de-energize.
system—a collection of mechanisms, devices, machines, articles of manufacture, processes, data, and/or instructions, the collection designed to perform one or more specific functions.
thermistor—a resistor having a resistance that substantially varies in response to relatively small changes in its temperature.
threshold—a point that when exceeded produces a given effect or result.
transfer—(n) a transmission from one device, place, and/or state to another. (v) to convey from one device, place, and/or state to another.
transmit—to provide, furnish, supply, send as a signal, and/or to convey (e.g., force, energy, and/or information) from one place and/or thing to another.
user interface—a device and/or software program for rendering information to a user and/or requesting information from the user. A user interface can include at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.
via—by way of and/or utilizing.
volt—a unit of measure of electrical potential that is defined by an electrical potential difference across a conductor when a current of one ampere dissipates one watt of power.
voltage—(a.k.a., “potential difference” and “electromotive force” (EMF)) a difference in electrical potential between any two conductors of an electrical circuit and/or a quantity, expressed as a signed number of Volts (V), and measured as a signed difference between two points in an electrical circuit which, when divided by the resistance in Ohms between those points, gives the current flowing between those points in Amperes, according to Ohm's Law.
wherein—in regard to which; and; and/or in addition to.
zener diode—a two-terminal device that permits current to flow in a forward direction and also permits current flow in a reverse direction when an applied voltage is larger than a breakdown voltage.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive.

What is claimed is:

1. A system comprising:
a digital camera; and
an input/output (I/O) circuit adapted to be communicatively coupled to said digital camera, said I/O circuit adapted to transmit direct current signals of a positive polarity relative to ground, said I/O circuit adapted to transmit direct current signals of a negative polarity relative to ground, said I/O circuit comprising a bidirectional zener diode adapted to establish a voltage threshold of an input to said I/O circuit.

2. The system of claim 1, wherein:
said bidirectional zener diode is electrically coupled a pair of back-to-back current limiting diodes, said pair of back-to-back current limiting diodes adapted to determine a power dissipation of said I/O circuit.

3. The system of claim 1, wherein:
said bidirectional zener diode is electrically coupled with a threshold resistor, said threshold voltage established by said bidirectional zener diode and said threshold resistor.

4. The system of claim 1, wherein:
said I/O circuit comprises a thermistor, said thermistor adapted to limit a maximum power dissipation of said I/O circuit.

5. The system of claim 1, wherein:
said I/O circuit comprises a constant current diode, said constant current diode adapted to limit a maximum power dissipation of said I/O circuit.

6. The system of claim 1, wherein:
said I/O circuit is adapted to transmit an analog signal.

7. The system of claim 1, wherein:
said I/O circuit is adapted to transmit a signal of approximately 12 volts.

8. The system of claim 1, wherein:
said I/O circuit is adapted to transmit a signal of approximately 24 volts.

9. The system of claim 1, wherein:
said I/O circuit is adapted to transmit a bidirectional signal.

10. The system of claim 1, wherein:
said threshold voltage is approximately half of a reference voltage applied to said I/O circuit.

11. The system of claim 1, wherein:
power dissipated by said I/O circuit proportional to a voltage input to said I/O circuit.

12. A system comprising:
a digital camera; and
an input/output (I/O) circuit adapted to be communicatively coupled to said digital camera, said I/O circuit adapted to transmit direct current signals of a positive polarity relative to ground, said I/O circuit adapted to transmit direct current signals of a negative polarity relative to ground, power dissipated by said I/O circuit proportional to a voltage input to said I/O circuit.

13. An input/output (I/O) circuit comprising:
a bidirectional zener diode; and
a threshold resistor electrically coupled to said bidirectional zener diode, said bidirectional zener diode and said threshold resistor adapted to establish a threshold voltage of an input to said I/O circuit, said I/O circuit adapted to transmit direct current signals of a positive polarity relative to ground, said I/O circuit adapted to transmit direct current signals of a negative polarity relative to ground.
